(19) United States
(12) Patent Application Publication
(10) Pub. No.: US 2012/0076211 A1
(43) Pub. Date: Mar. 29, 2012

(54) Systems and Methods for Facilitating Power Line Communications

(75) Inventors: Badri N. Varadarajan, Mountain View, CA (US); Anand G. Dabak, Plano, TX (US); Il Han Kim, Dallas, TX (US)

(73) Assignee: TEXAS INSTRUMENTS INCORPORATED, Dallas, TX (US)

(21) Appl. No.: 13/229,650

(22) Filed: Sep. 9, 2011

Related U.S. Application Data
(60) Provisional application No. 61/386,246, filed on Sep. 24, 2010.
(60) Provisional application No. 61/391,373, filed on Oct. 8, 2010.

(51) Int. Cl. H04B 3/54

(52) U.S. Cl. 375/257

(57) ABSTRACT

Systems and methods for facilitating power line communications are described. In some embodiments, a PLC device may detect the availability of a first frequency band as well the availability of a combination of a second frequency band with a third frequency band. The PLC device may then communicate with another PLC device using a frequency band selected as (a) at least a portion of a combination of the first, second, and third frequency bands, (b) at least a portion of the first frequency band, or (c) at least a portion of the combination of the second with third frequency bands. The PLC device may further transmit a message to a higher-level PLC apparatus (e.g., a domain master) over the power line using a device-based access mode, receive an instruction to switch to a domain-based access mode, and thereafter communicate with another PLC device using the domain-based access mode.

### CROSS-REFERENCE TO RELATED APPLICATIONS

This application claims the benefit of the filing date of U.S. Provisional Patent Application No. 61/386,246, which is titled “Methods for G.hnem to Specify Operation in Cenelec B/C/D Bands” and was filed Sep. 24, 2010, and U.S. Provisional Patent Application No. 61/391,373, which is titled “Methods for G.hnem to Specify Operation in Cenelec B/C/D Bands” and was filed Oct. 8, 2010, the disclosures of which are hereby incorporated by reference herein in their entireties.

### TECHNICAL FIELD

Embodiments are directed, in general, to network communications, and, more specifically, to systems and methods for facilitating power line communications.

### BACKGROUND

Power line communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

Various PLC standardizing efforts are currently being undertaken around the world, each with its own unique characteristics. Generally speaking, PLC systems may be implemented differently depending upon local regulations, characteristics of local power grids, etc. Examples of competing PLC standards include the IEEE 1901, HomePlug AV, and ITU-T G.hn (e.g., G.9960 and G.9961) specifications.

### SUMMARY

Systems and methods for facilitating power line communications are described. In an embodiment, a PLC device may include a processor and a memory coupled to the processor. The memory may be configured to store program instructions, and the program instructions may be executable by the processor to cause the PLC device to detect, via a power line coupled to the PLC device, the availability of a first frequency band as well as the availability of a combination of a second frequency band with a third frequency band. The PLC may also select an operating frequency band, the operating frequency band including: (a) a combination of the first, second, and third frequency bands in response to a determination that the first frequency band and the combination of second with third frequency bands are both available, (b) the first frequency band in response to a determination that the first frequency band is available but the combination of the second with third frequency bands is unavailable, or (c) the combination of the second with third frequency bands in response to a determination that the combination of the second with third frequency bands is available but the first frequency band is unavailable. Thereafter, the PLC device may communicate with another PLC device over the power line using the operating frequency band.

In some implementations, the second frequency band may be contiguous with the first frequency band and the third frequency band may be contiguous with the second frequency band. For example, the first frequency band may include frequencies between 95 kHz and 125 kHz, the second frequency band may include frequencies between 125 kHz and 140 kHz, and the third frequency band may include frequencies between 140 kHz and 148.5 kHz. Additionally or alternatively, the first frequency band may be approximately twice as large as the second frequency band and approximately four times as large as the third frequency band.

In other implementations, each of the first, second, and third frequency bands may enable a different type of PLC application. Moreover, the second frequency band may be configured to support communications using a specific protocol that is different from other protocols used in the first or third frequency bands (e.g., user defined protocols, etc.).

To monitor the availability of the first frequency band, the program instructions, upon execution by the processor, may cause the PLC device to perform a carrier sensing operation. Conversely, to monitor the availability of the combination of second with third frequency bands, the program instructions, upon execution by the processor, may cause the PLC device to perform a band-in-use operation.

In some embodiments, the PLC device may transmit a message to a higher-level PLC apparatus over the power line with the operating frequency band using device-based access rules. The PLC device may, in response to the message, receive an instruction from the higher-level PLC apparatus that the PLC device switch to a domain-based access mode. Then, in response to the instruction, the PLC device may communicate with the another PLC device over the power line with the operating frequency band using domain-based access rules. For example, the higher-level PLC apparatus may be a domain master device or the like.

Additionally or alternatively, one or more of the techniques may be implemented as a method performed by one or more PLC devices or systems. Additionally or alternatively, a tangible computer-readable storage medium may have program instructions stored thereon that, upon execution by one or more PLC devices, cause the one or more PLC devices to execute one or more operations disclosed herein.

### BRIEF DESCRIPTION OF THE DRAWINGS

Having thus described the invention(s) in general terms, reference will now be made to the accompanying drawings, wherein:

FIG. 1 is a diagram of a PLC environment according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator according to some embodiments.

FIG. 5 is a diagram illustrating a new PLC device and/or PLC gateway joining an existing PLC environment according to some embodiments.

FIG. 6 is a graph of PLC spectral bandwidth according to some embodiments.

FIG. 7 is a graph of contiguous PLC frequency bands according to some embodiments.

FIG. 8 is a flowchart of a method for selecting an operating frequency band according to some embodiments.

FIG. 9 is diagram of communication events following device-based access rules according to some embodiments.

FIG. 10 is diagram of communication events following domain-based access rules according to some embodiments.

FIG. 11 is a flowchart of a method for determining a mode of operation according to some embodiments.

FIG. 12 is a block diagram of an integrated circuit according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

Agreements concerning various power line communication (PLC) standards have been made. For instance, the ITU-T G.hnem, IEEE 1901.2 standard includes architecture aspects of the physical (PHY) layer and the media access control (MAC) layer of PLC's open system interconnection (OSI) model. Network architectures are also being discussed. In addition, various standardizing bodies have set forth frequency restrictions for PLC communications. For example, the European Committee for Electromechanical Standardization (CENELEC) currently allows the implementation of such communications in the ˜3 kHz-148.5 kHz frequency range only, and this prescribed spectrum is further divided into smaller bands allocated for particular applications.

Specifically, CENELEC's “A” band includes frequencies in the 3-95 kHz range, and it is dedicated to electricity suppliers (i.e., “access” applications such as metering, etc.). CENELEC's “B” band includes frequencies in the 95-125 kHz range for consumer applications that may involve the user of higher data rates. The “C” band includes frequencies in the 125-140 kHz range, also for consumer use, but requires that a specific protocol be followed. The “D” band includes frequencies in the 140-148.5 kHz range for consumer applications that involve the use lower data rates. (At the present time, neither the B-band nor the D-band communications mandates the use of a special protocol.) Examples of PLC applications include, but are not limited to, access communications, alternating current (AC) charging, direct current (DC) charging, in-premises connectivity (e.g., home networking), etc.

Although various examples described herein are discussed in the context of CENELEC regulations, it should be understood that the disclosed techniques may be similarly applicable to other environments and/or geographic regions. In the U.S., for example, the Federal Communications Commission (FCC) presently requires that PLC communications occupy the spectrum between ˜9-534 kHz, without subband restrictions unlike its European counterpart. Nonetheless, the inventors hereof recognize that the that the use of sub-bands in the U.S. may evolve in such a way that at least a portion of the prescribed spectrum may also be sub-divided for different types of applications.

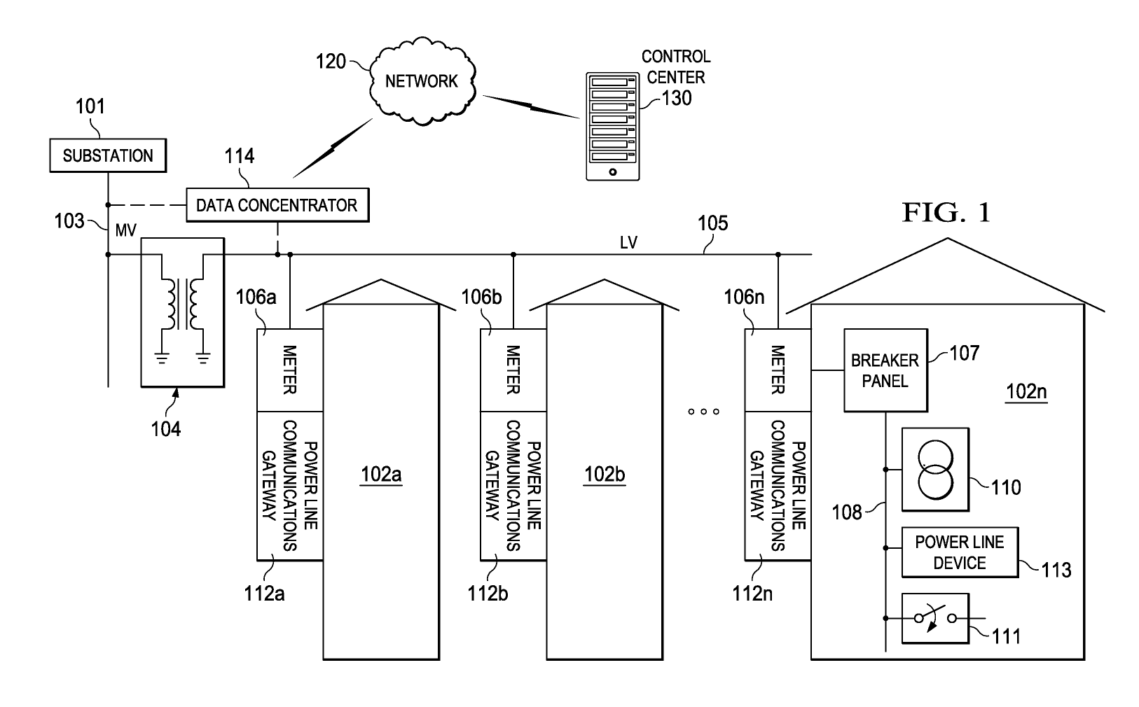

Turning now to FIG. 1, an electric power distribution system is depicted according to some embodiments. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. (Although referred to as “residences,” premises 102a-n may include any type of building, facility or location where electric power is received and/or consumed.) A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use, for example, a carrier signal having a frequency different from that of the power signal. The carrier signal may be modulated by the data, for example, using an orthogonal frequency division multiplexing (OFDM) scheme or the like.

PLC modems or gateways 112a-n at residences 102a-n use the MV/LV power grid to carry data signals to and from PLC data concentrator 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, PLC networks may provide street lighting control and remote power meter data collection.

One or more concentrators 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

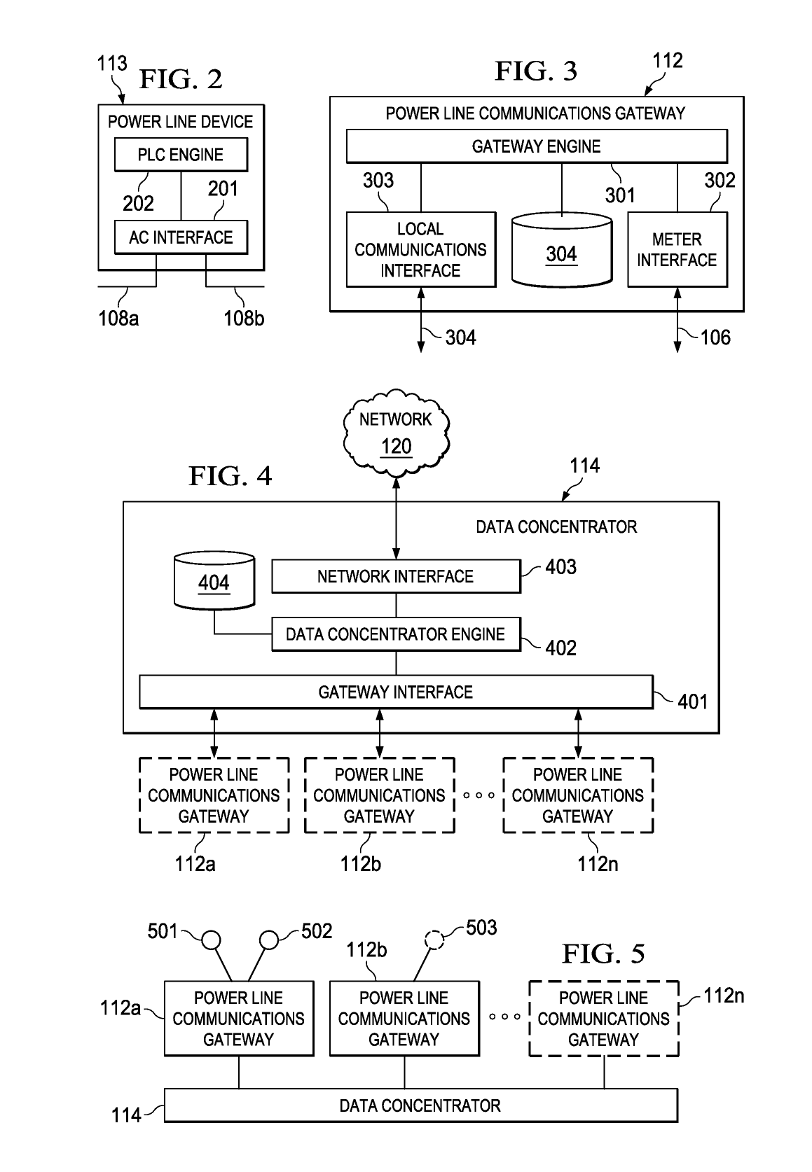

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate. In various embodiments described in more detail below, the frequency band in which PLC device 113 operates may be selected or otherwise allocated based, at least in part, upon the availability of a frequency spectrum having two or more sub-bands.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZigBee®, Bluetooth®, WiFi™, WiMax™, Ethernet, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 304 in assigning, allocating, or otherwise managing frequency bands assigned to its various PLC devices.

FIG. 4 is a block diagram of a PLC data concentrator according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

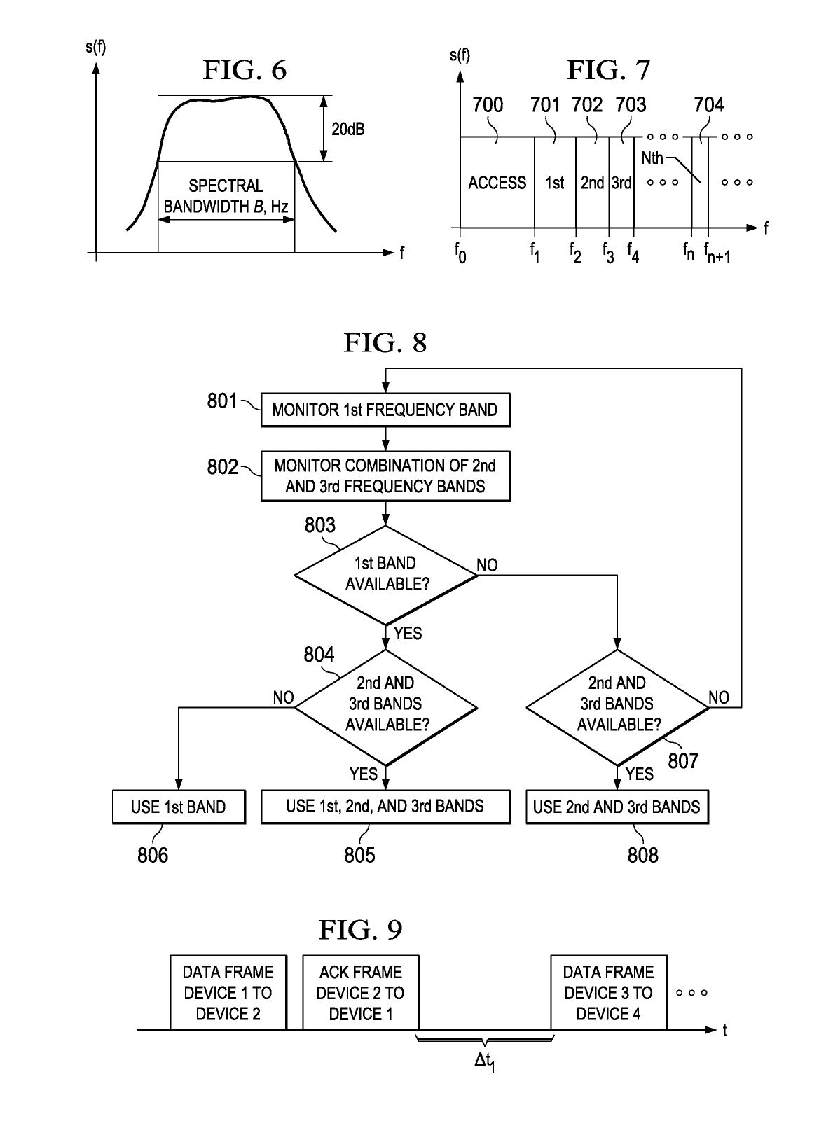

FIG. 5 is a diagram illustrating a new PLC device and gateway entering a PLC environment according to some embodiments. In this example, PLC devices 501 and 502 are currently communicating with PLC data concentrator 114 via PLC gateway 112a, each device operating within its designated frequency band. Also, PLC gateway 112b is already “online” and configured to communicate with PLC data concentrator 114. In this environment, a new PLC device 503 may be introduced into the system, and therefore a determination may be made as to its mode of operation (e.g., device-level or domain-level) and/or as to its frequency of operation (e.g., one or more frequency bands). The mode operation determination may be based, for example, upon PLC device 503's interaction with PLC gateway 112a and/or another device service as a domain master (as shown, for example, in FIGS. 6-8). The operating frequency determination may also be performed, for example, by PLC device 503 upon power up (as shown, for example, in FIGS. 9-11) or sometime thereafter. Similar determination(s) may be performed by new PLC gateway 112n when introduced into the same PLC network (e.g., its “domain master” may be concentrator 144).

In various embodiments, a “lower-level” PLC device may include any device, modem, system, or apparatus that is placed “downstream” from a “higher-level” PLC device. For example, still referring to FIG. 5, it may be said that PLC device 503 is a lower-level device with respect to both PLC gateway 112b and PLC concentrator 114. Meanwhile, PLC gateway 112b may be considered a higher-level device with respect to PLC device 503, and a lower-level device with respect to PLC concentrator 114. Furthermore, in various embodiments, a higher-level PLC device may be the domain master for a lower-level PLC device, and therefore may be gather information about the usage of each band and/or subband, and may allocate new band(s) and/or subband(s) for other device(s).

Generally speaking, a PLC device may select a mode of operation as well as an operating frequency. In some embodiments, the PLC device may perform operating frequency determinations prior to selecting a particular mode of operation. Alternatively, the PLC device may select a mode of operation and then make an operating frequency determinations. Moreover, during the course of its operations, the same PLC device may change is frequency band and/or mode of operation, for example, as a function of changing conditions in the PLC network.

As previously noted, a PLC device may determine its operating frequency band, as described below with respect to FIGS. 6-8. Turning to FIG. 6, a graph of PLC spectral bandwidth is depicted according to some embodiments. Particularly, CENELEC specifies maximum values of both in-band and out-of-band emissions levels, with the band occupied measured as the length of the interval where all the frequency lines are less than 20 dB below the maximum spectral line. In other embodiments, however, other suitable restrictions may be placed on frequency band usage.

FIG. 7 is a graph of contiguous PLC frequency bands according to some embodiments. In some embodiments, each PLC frequency band may be such as shown in FIG. 6. As illustrated, access band 700 spans frequency f₀ through frequency f₁, first frequency band 701 spans frequencies f₁ through f₂, second frequency band 702 spans frequencies f₂ through f₃, third frequency band 701 spans frequencies f₃ through frequency f₄, and so on until Nth frequency band 704, which spans frequencies fₙ through fₙ₊₁. In other words, second frequency band 702 is contiguous with first frequency band 701, and third frequency band 703 is contiguous with second frequency band 702. An alternative embodiment may not include access band 700, or may position access band 700 elsewhere along the spectrum.

In the case of a CELENEC implementation, f₀ may be approximately 3 kHz, f₁ may be approximately 95 kHz, f₂ may be approximately 125 kHz, f₃ may be approximately 140 kHz, f₄ may be approximately 148.5 kHz, and the Nth frequency band may be absent. In various embodiments, the term “approximately” may be used to include values within 25%, 10%, 5%, or 1% of each other. As such, first frequency band 701 may include CENELEC's B-band, second frequency band 702 may include CENELEC's C-band, and third frequency band 703 may include CENELEC's D-band.

Still referring to the non-limiting case of a CENELEC implementation, the inventors hereof have recognized that is not yet clear from whether use of B and D bands (without the C band) is allowed by the standard. The inventors have also recognized that it would be difficult, in practice, to use deep notch filters between two occupied bands (e.g., bands B and D). Therefore, in various embodiments, the following operating bands may be assigned to, or otherwise selected by, a PLC device: CENELEC B band (e.g., first frequency band 701 spanning f₁ through f₂), a combination of CENELEC C and D bands (e.g., a combination of the second and third frequency bands 702 and 703 spanning f₂ through f₄), or a combination of all of B, C, and D bands (e.g., a combination of the first, second, and third frequency bands 701-703 spanning f₁ through f₄). In other words, no mode is defined where only CENELEC B and D bands are in use, while CENELEC C band is unoccupied. Additionally or alternatively, some embodiments may define device operation in the CENELEC D band alone (e.g., third frequency band 703).

Although described above in the context of CENELEC bands, various techniques discussed herein may be also applicable in the context of FCC band(s) (e.g., 10 kHz to 490 kHz), Association of Radio Industries and Businesses (ARIB) band(s) (e.g., 10 kHz to 450 kHz) and/or any other such band(s).

Turning now to FIG. 8, a flowchart of a method for selecting an operating frequency band is depicted according to some embodiments. In some implementations, the method of FIG. 8 may be performed by PLC device 113, PLC gateway 112n, and/or PLC concentrator 114, for example, during initial power up or during a reconfiguration procedure. At block 801, PLC device 113 may monitor a first frequency band (e.g., band 701 in FIG. 7). At block 802, PLC device 113 may monitor a combination of second and third frequency bands (e.g., bands 702 and 703). At block 803, PLC device 113 may determine whether the first frequency band is available. If so, control passes to block 804, where PLC device 113 determines whether the combination of second and third frequency bands is also available. In response to the first frequency band and the combination of second and third frequency bands being available, at block 805 PLC device 113 may select a combination of the first, second, and third frequency bands as its operating frequency; otherwise, at block 806, PLC device 113 may select only the first frequency band. If, at block 803, PLC device 113 determines that the first frequency band is not available, control passes to block 807. At block 807, PLC device 113 determines whether the combination of second and third frequency bands is available. If so, at block 808, PLC device 113 may select the combination of second and third frequency bands as its operating frequency. Otherwise, control may return to block 801 and PLC device 113 may continue monitoring the network.

In some cases, monitoring of the availability of the first frequency band in block 801 may be performed using a carrier sensing operation. In other cases, monitoring the availability of the combination of second with third frequency bands in block 802 may include performing a band-in-use operation, as described, for example, by EN50065-1, July 2001, “Signaling on low-voltage electrical installations in the frequency range 3 kHz to 148.5 kHz.”

In some embodiments, the method shown in FIG. 8 may be performed by a higher-level PLC apparatus, such as a domain master (e.g., PLC gateway 112 or PLC concentrator 114) or the like. For example, PLC device 113 may send a message to the domain master requesting a frequency allocation, and the domain master may perform the monitoring operations of blocks 801 and 802. Additionally or alternatively, the domain master may look up current frequency usage information stored in a database (e.g., databases 304 and/or 404 in FIGS. 3 and 4).

Still referring to FIG. 8, in the particular case of a CENELEC application, the PLC device's band of operation may be selected in at least one of two ways. First, all devices in a domain may operate in one of B-band alone, C+D bands alone, or B+C+D bands. A device may determine the band on which the domain operates and may use it in subsequent communications. To do this, the device may search for the domain master on all band combinations. Second, each device may select the band of transmission independent from one frame to the other following certain principles. Particularly, each device may track the occupancy of both the B band and the (C+D) band. For example, with respect to the B band, occupancy may be determined using a carrier sensing technique. For the C+D band, the band-in-use conditions from EN50065-1 may be used to determine if the band is free. At the start of each frame, the device may pick one of the three bands above for transmission. If the entire (B+C+D) band is free (e.g., for the entire duration of the frame), then this band may be used. If only one of the two smaller bands (B or C+D) is available (e.g., for the entire duration of the frame), then the available smaller band is used. A receiver (e.g., the receiver portion of AC interface 201 of FIG. 2, for example) may look for preamble transmission in the B band and in the (C+D) band. If a preamble is detected in either band, the receiver may attempt to decode the header both in that band alone and in the entire (B+C+D) band. Depending on which header passes, the packet may be decoded. In some embodiments, a PLC device may operate in either of the two subbands to exploit the available channel throughput on a per-frame basis.

In addition to its frequency band, a PLC device may also select or otherwise determine its mode of operation, which is described below with respect to FIGS. 9-11. Prior to considering these techniques, however, it may be noted that one or more frequency bands shown in FIG. 7 may have its own specific protocol, which may be different from other protocols of other frequency bands. In the case of CENELEC implementation, for example, the C-band (e.g., second frequency bands 702) is regulated in such a way that (1) band-in-use indication may be obtained by measuring energy in from 131.5-133.5 kHz. Annex B of the EN50065-1 document specifies spectral characteristics that mandate a minimum fraction of the energy to be concentrated around 132.5 kHz. Thus, whenever CENELEC-C band is used, at least a certain fraction of the energy may be in 132.5 kHz to enable other receivers to detect the band-in-use condition. Also, (2) if a transmitter or a group of transmitters has used the channel for 1 sec (with gaps less than 80 ms between transmissions), it has to avoid transmission for at least 125 ms. Furthermore, (3) each transmitter or group of transmitters can only transmit if the band has not been in use for a period from 85-115 ms.

Turning now to FIG. 9, a diagram of communication events following device-based access rules is depicted according to some embodiments. In this example, PLC devices 1 and 2 exchange a data frame and an acknowledgment frame. PLC device 3 detects that the channel is free, and waits 85-115 ms (AO before it transmits its own data frame to PLC device 4. In sum, each (pair of) ITU-T G.hnem device(s) using the CENELEC-C band independently follows constraints (1)-(3) above. According to rule (3), this implies a 85-115 ms gap between one transmission and another.

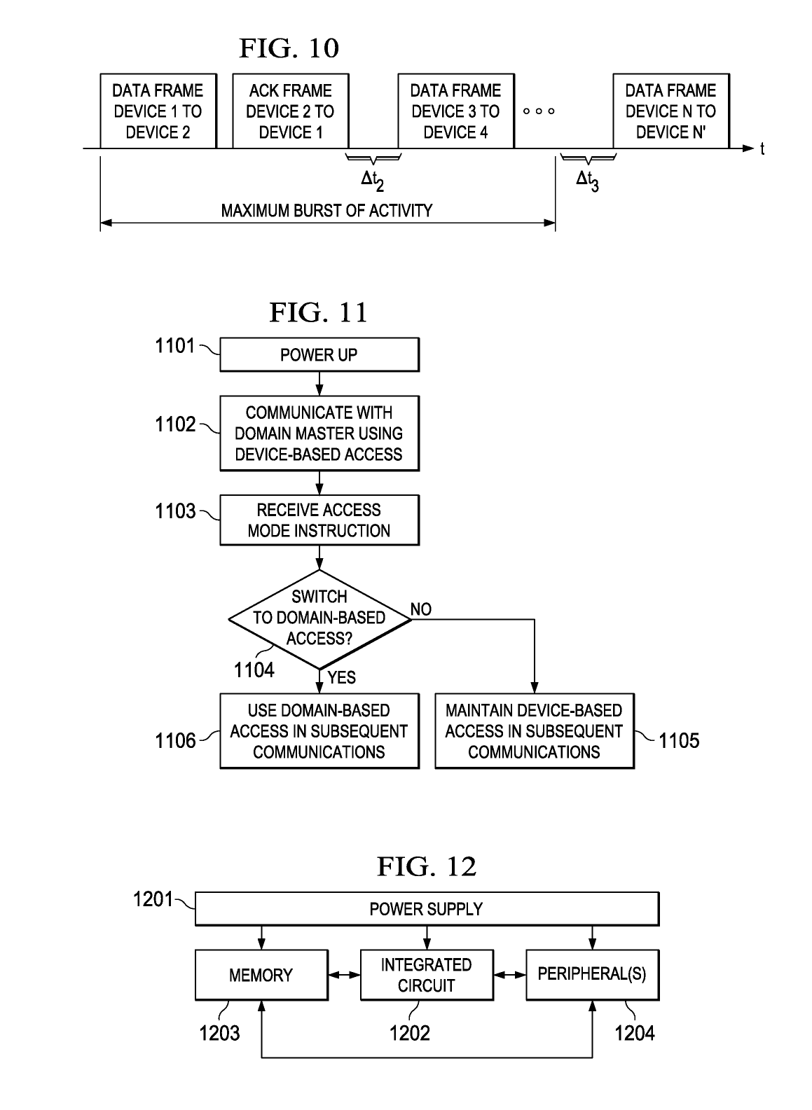

FIG. 10 is diagram of communication events following domain-based access rules according to some embodiments. Particularly, PLC devices 1 and 2 exchange a data frame and an acknowledgment frame, as before. Similarly, device 3 detects that the channel is free, and transmits its data frame to device 4 after waiting for a specified period of time Δt₂. After a maximum burst of activity period followed by another waiting period Δt₃, device N may transmit a data packet to device N′. As such, all devices in a domain may be treated as a group of transmitters. This mode of operation may relax the constraint of at least 85 ms between each transmission (i.e., Δt₂<85 ms), but it may require that every domain have a silent period of at least 125 ms after every (domain-level) burst of activity lasting 1 sec (i.e., “maximum burst of activity”=1 s and Δt₃=125 ms). Further, each node operating in domain-based access mode may monitor use of the channel by other nodes in the same domain, and back off accordingly.

In various embodiments, a consistent set of rules may be maintained by all PLC devices connected to the same network; that is, either all devices implement the channel access rule independently (as in FIG. 9) or they implement them as a group (as in FIG. 10). In some cases, device-based access mode or rules may be more suitable when there are only a few nodes in the domain with infrequent activity. In these cases, a delay of 85-115 ms between (transmission-acknowledgement) pairs may be unlikely to cause significant throughput impact. It also relaxes the requirement for each PLC device to constantly monitor all traffic in the domain. Conversely, domain-based access mode or rules may be more suitable for loaded domains with frequent activity, where nodes are likely to monitor domain activity frequency and the throughput increase from domain-level access rules is significant.

FIG. 11 is a flowchart of a method for determining a mode of operation according to some embodiments. In some cases, the method of FIG. 11 may be performed by a lower-level PLC device (e.g., PLC device 113) in conjunction with a higher-level PLC device or domain master (e.g., PLC gateway 112 and/or PLC concentrator 114). At block 1101, the PLC device may power up. At block 1102, the PLC device may communicate with a domain master using a device-based access mode. At block 1103, the PLC device may receive an instruction from the domain master. If it is determined at block 1104 that the instruction requests that the PLC device switch operations to a domain-based mode, the PLC device may then switch to such mode at block 1106. On the other hand, if it is determined at block 1104 that the instruction requests that the PLC device maintain device-based operations, the PLC device may comply in block 1105.

In sum, in some embodiments, all nodes in a domain may configured by the domain master to follow either device-level or domain-level access control. Each device on power-up may follow device-level access control. In some cases, block 1102 may be replaced with a monitoring operation such that, at block 1103, the PLC device may determine the mode used for that domain based on a beacon or other domain-level management information broadcast over the network. The PLC device may then follow the requested mode after registration with the domain.

FIG. 12 is a block diagram of an integrated circuit according to some embodiments. In some cases, one or more of the devices and/or apparatuses shown in FIGS. 1-4 may be implemented as shown in FIG. 12. In some embodiments, integrated circuit 1202 may be a digital signal processor (DSP), an application specific integrated circuit (ASIC), a system-on-chip (SoC) circuit, a field-programmable gate array (FPGA), a microprocessor, a microcontroller, or the like. Integrated circuit 1202 is coupled to one or more peripherals 1204 and external memory 1203. In some cases, external memory 1203 may be used to store and/or maintain databases 304 and/or 404 shown in FIGS. 3 and 4. Further, integrated circuit 1202 may include a driver for communicating signals to external memory 1203 and another driver for communicating signals to peripherals 1204. Power supply 1201 is also provided which supplies the supply voltages to integrated circuit 1202 as well as one or more supply voltages to memory 1203 and/or peripherals 1204. In some embodiments, more than one instance of integrated circuit 1202 may be included (and more than one external memory 1203 may be included as well).

Peripherals 1204 may include any desired circuitry, depending on the type of PLC system. For example, in an embodiment, peripherals 1204 may implement local communication interface 303 and include devices for various types of wireless communication, such as WiFi™, ZigBee®, Bluetooth®, cellular, global positioning system, etc. Peripherals 1204 may also include additional storage, including RAM storage, solid state storage, or disk storage. In some cases, peripherals 1204 may include user interface devices such as a display screen, including touch display screens or multi-touch display screens, keyboard or other input devices, microphones, speakers, etc.

External memory 1203 may include any type of memory. For example, external memory 1203 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, Rambus® DRAM, etc. External memory 1203 may include one or more memory modules to which the memory devices are mounted, such as single inline memory modules (SIMMs), dual inline memory modules (DIMMs), etc.

It will be understood that various operations illustrated in FIGS. 8 and 11 may be executed simultaneously and/or sequentially. It will be further understood that each operation may be performed in any order and may be performed once or repetitiously. In various embodiments, the modules shown in FIGS. 2-4 may represent sets of software routines, logic functions, and/or data structures that are configured to perform specified operations. Although these modules are shown as distinct logical blocks, in other embodiments at least some of the operations performed by these modules may be combined in to fewer blocks. Conversely, any given one of the modules shown in FIGS. 2-4 may be implemented such that its operations are divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc. Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A power line communication (PLC) device comprising:
a processor; and
a memory coupled to the processor, the memory configured to store program instructions,
the program instructions executable by the processor to cause the PLC device to:
detect, via a power line coupled to the PLC device, availability of (a) a first frequency band and of (b) a combination of a second frequency band with a third frequency band, wherein the second frequency band is contiguous with the first frequency band and the third frequency band is contiguous with the second frequency band;
select an operating frequency band, the operating frequency band including: (a) a combination of the first, second, and third frequency bands in response to a determination that the first frequency band and the combination of second with third frequency bands are both available, (b) the first frequency band in response to a determination that the first frequency band is available but the combination of the second with third frequency bands is unavailable, or (c) the combination of the second with third frequency bands in response to a determination that the combination of the second with third frequency bands is available but the first frequency band is unavailable; and
communicate with another PLC device over the power line using the operating frequency band.

2. The PLC device of claim 1, wherein to monitor the availability of the first frequency band, the program instructions, upon execution by the processor, further cause the PLC device to perform a carrier sensing operation.

3. The PLC device of claim 2, wherein to monitor the availability of the combination of second with third frequency bands, the program instructions, upon execution by the processor, further cause the PLC device to perform a band-in-use operation.

4. The PLC device of claim 1, wherein the first frequency band includes frequencies between 95 kHz and 125 kHz, the second frequency band includes frequencies between 125 kHz and 140 kHz, and the third frequency band includes frequencies between 140 kHz and 148.5 kHz.

5. The PLC device of claim 1, wherein the first frequency band is approximately twice as large as the second frequency band and approximately four times as large as the third frequency band.

6. The PLC device of claim 1, wherein each of the first, second, and third frequency bands enables a different type of PLC application.

7. The PLC device of claim 1, wherein the second frequency band is configured to support communications using a protocol that is different from other protocols used in the first or third frequency bands.

8. The PLC device of claim 1, wherein to communicate with the another PLC device over the power line using the selected operating frequency band, the program instructions are further executable by the processor to cause the PLC device to:
transmit a message to a higher-level PLC apparatus over the power line with the operating frequency band using a device-based access mode;
in response to the message, receive an instruction from the higher-level PLC apparatus that the PLC device switch to a domain-based access mode; and
in response to the instruction, communicate with the another PLC device over the power line with the operating frequency band using the domain-based access mode.

9. The PLC device of claim 8, wherein the higher-level PLC apparatus is a domain master device.

10. A tangible computer-readable storage medium having program instructions stored thereon that, upon execution by a power line communication (PLC) device, cause the PLC device to:
detect, via a power line coupled to the PLC device, availability of (a) a first frequency band and of (b) a combination of a second frequency band with a third frequency band; and
communicate with another PLC device over the power line using a selected frequency band, the selected frequency band including (a) at least a portion of a combination of the first, second, and third frequency bands in response to a determination that the first frequency band and the combination of second with third frequency bands are available, (b) at least a portion of the first frequency band in response to a determination that the first frequency band is available but the combination of the second with third frequency bands is unavailable, or (c) at least a portion of the combination of the second with third frequency bands in response to a determination that the combination of the second with third frequency bands is available but the first frequency band is unavailable.

11. The tangible computer-readable storage medium of claim 10, wherein to monitor the availability of the first frequency band, the program instructions, upon execution by the PLC device, further cause the PLC device to perform a carrier sensing operation.

12. The tangible computer-readable storage medium of claim 10, wherein to monitor the availability of the combination of second with third frequency bands, the program instructions, upon execution by the PLC device, further cause the PLC device to perform a band-in-use operation.

13. The tangible computer-readable storage medium of claim 10, wherein the second frequency band is contiguous with the first frequency band, the third frequency band is contiguous with the second frequency band, and the second frequency band is configured to support communications using a protocol that is different from other protocols used in the first or third frequency bands.

14. The tangible computer-readable storage medium of claim 10, wherein to communicate with the another PLC device over the power line using the selected operating frequency band, the program instructions are further executable by the PLC device to cause the PLC device to:
transmit a message to a higher-level PLC apparatus over the power line with the selected frequency band using a device-based access mode;
in response to the message, receive an instruction from the higher-level PLC apparatus that the PLC device switch to a domain-based access mode; and
in response to the instruction, communicate with the another PLC device over the power line with the selected frequency band using the domain-based access mode.

15. The tangible computer-readable storage medium of claim 14, wherein the higher-level PLC apparatus is a domain master.

16. A method comprising:
performing, by a power line communication (PLC) device,
detecting, via a power line coupled to the PLC device, availability of (a) a first frequency band and of (b) a combination of a second frequency band with a third frequency band; and
communicating with another PLC device over the power line using a frequency band selected as (a) at least a portion of a combination of the first, second, and third frequency bands in response to a determination that the first frequency band and the combination of second with third frequency bands are available, (b) at least a portion of the first frequency band in response to a determination that the first frequency band is available but the combination of the second with third frequency bands is unavailable, or (c) at least a portion of the combination of the second with third frequency bands in response to a determination that the combination of the second with third frequency bands is available but the first frequency band is unavailable.

17. The method of claim 16, wherein monitoring the availability of the first frequency band includes performing a carrier sensing operation.

18. The method of claim 16, wherein monitoring the availability of the combination of second with third frequency bands including performing a band-in-use operation.

19. The method of claim 16, wherein the second frequency band is contiguous with the first frequency band, the third frequency band is contiguous with the second frequency band, and the second frequency band is configured to support communications using a protocol that is different from other protocols used in the first or third frequency bands.

20. The method of claim 19, wherein communicating with the another PLC device further comprises:
performing, by the PLC device,
transmitting a message to a higher-level PLC apparatus over the power line using a device-based access mode;
in response to the message, receiving an instruction from the higher-level PLC apparatus that the PLC device switch to a domain-based access mode; and
in response to the instruction, communicating with the another PLC device over the power line using the domain-based access mode.
